(19) United States
(12) Patent Application Publication
(10) Pub. No.: US 2011/0222022 A1
(43) Pub. Date: Sep. 15, 2011

(54) IMAGE DISPLAY DEVICE

(75) Inventor: Yoshitaka Sato, Kanagawa (JP)

(73) Assignee: COLORLINK. JAPAN LIMITED, Joetsu-shi, Niigata (JP)

(21) Appl. No.: 13/130,314

(22) PCT Filed: Dec. 17, 2009
(86) PCT No.: PCT/JP2009/006992

§ 371 Date: May 20, 2011

(30) Foreign Application Priority Data
Dec. 17, 2008 (JP) 2008-321164

(51) Int. Cl. G03B 21/14

(52) U.S. Cl. 353/20

(57) ABSTRACT

An image display device which displays a three-dimensional image without alternately displaying right and left eye images, and utilizes substantially the same light for both two- and three-dimensional displays. The image display device includes: an LED light source having no polarization characteristics; a collimator lens collimating light from the LED light source; a condenser lens focusing the collimated light; a first polarizing prism separating the light transmitted by the condenser lens into S-polarized light and P-polarized light; a first polarized image former forming a P-polarized image from the S-polarized light reflected from the first polarizing prism; a second polarized image former forming an S-polarized image from the P-polarized light transmitted by the first polarizing prism; a second polarizing prism combining the P-polarized image and the S-polarized image; a projection lens projecting the combined image; and a screen.

### TECHNICAL FIELD

The present invention relates to an image display device.

### BACKGROUND ART

Polarization-controlled liquid crystal light valves for use in liquid crystal projectors are classified into the transmissive type and reflective type, and both types have been used in three-panel, two-panel, and one-panel projectors.

In three-panel systems, white light is separated into red, green, and blue wavebands by means of two dichroic mirrors, and these wavebands of light are combined by use of liquid crystal light valves for the corresponding colors. The resulting color image is then projected on an enlarged scale onto a screen by a projection lens. Three-panel systems provide high color reproducibility and a high resolution, but have a high component count and hence increased size.

One-panel systems, on the other hand, modulate red, green, and blue light using only one liquid crystal light valve, and therefore are advantageous in that they are compact and lightweight. For example, every three pixels in a liquid crystal light valve may be assigned red, green, and blue colors. However, this method is disadvantageous in that two-thirds of the light is always blocked, thus reducing the resolution and brightness to one-third.

Two-panel systems modulate two colors of light using one liquid crystal light valve and the remaining color of light using the other liquid crystal light valve.

FIG. 5 shows an image display device using a two-panel projector disclosed in Japanese Laid-Open Patent Publication No. 2002-40367. In this device, when white light 110 is incident on a temporal modulator 120, the temporal modulator 120 selectively polarizes specific spectral components of light 125. A first filter 130 then rotates the direction of polarization of a first spectral component 135 from within the spectral components 125 while transmitting a second spectral component 136, which is the remainder of the spectral components 125, without change. The first spectral component 135 and the second spectral component 136 are then separated by the reflecting/transmitting surface 145 of a beam splitter 140 and then separately incident on panels 150 and 160, respectively. The first spectral component 135 is rotated π/2 in polarization in a round-trip through the panel 150, then returns to the reflecting/transmitting surface 145 of the beam splitter 140, and recombines with the second spectral component 136 exiting the panel 160. The recombined light is rotated in polarization by a second optical polarizer 170 and displayed on the screen through a projection lens 180.

### CITATION LIST

PTL 1 Japanese Patent Application Laid-Open No. 2002-40367

### SUMMARY OF INVENTION

### Technical Problem

The above two-panel system may be regarded as a compromise between three- and one-panel systems. It should be noted that the image display device described in the above Japanese Laid-Open Patent Publication displays a two-dimensional image. In order to display a three-dimensional image in this device, right and left eye images may be alternately displayed on the screen. The observer wears glasses having liquid crystal shutters, and the right and left eye liquid crystal shutters are alternately opened and closed each time the display switches between the right and left eye images, thereby allowing the observer to see a three-dimensional image.

Alternatively, right and left eye images may be displayed in fields in an interleaved manner, and the right eye image light and left eye image light may be polarized to have a difference in polarization angle of 90 degrees by use of liquid crystal shutters which are provided for different fields and turned on and off separately by polarizing plates and a control device. The observer wears polarized glasses whose right and left lenses have a difference in polarization angle of 90 degrees, and looks at the displayed image, thereby perceiving a three-dimensional image.

However, the above methods using liquid crystal shutters are disadvantageous in that crosstalk and flicker is likely to occur between the left and right images. Further, since the left and right eye images are alternately displayed, the brightness is reduced to half its normal value.

The present invention has been made in view of these problems. It is, therefore, an object of the present invention to provide an image display device which displays a three-dimensional image without the need to alternately display right and left eye images, and which achieves substantially the same utilization of light for both two- and three-dimensional displays.

### Solution to Problem

In the image display device according to the present invention, the device comprises: a light source, a collimated light generating means for converting light from a light source into collimated light, a separating means for separating collimated light into S-polarized light and P-polarized light, a first polarized image forming means for forming a P-polarized image from S-polarized light, a second polarized image forming means for forming an S-polarized image from P-polarized light, a combining means for combining a P-polarized image and a S-polarized image, and a projecting means for projecting the combined image.

A first polarized image forming means includes a first reflective liquid crystal device which receives image information of a first color in S-polarized light, a second reflective liquid crystal device which receives image information of a second color in S-polarized light, and also receives image information of a third color in S-polarized light, two polarization direction control means for controlling the directions of polarization of light of the first color, light of the second color, and light of the third color, and a light splitting/combining means for reflecting (or transmitting) light of the first color toward the first reflective liquid crystal device, transmitting (or reflecting) light of the second color and light of the third color toward the second reflective liquid crystal device, and combining light reflected from the first reflective liquid crystal device and light reflected from the second reflective liquid crystal device.

A second polarized image forming means includes a third reflective liquid crystal device which receives image information of the first color in P-polarized light, a fourth reflective liquid crystal device which receives image information of the second color in P-polarized light and also receives image information of the third color in P-polarized light, two polarization direction control means for controlling the directions of polarization of light of the first color, light of the second color, and light of the third color, and a light splitting/combining means for reflecting (or transmitting) light of the first color toward the third reflective liquid crystal device, transmitting (or reflecting) light of the second color and light of the third color toward the fourth reflective liquid crystal device, and combining light reflected from the third reflective liquid crystal device and light reflected from the fourth reflective liquid crystal device.

In the image display device according to the present invention, the image information can be selectively switched between two-dimensional image information and three-dimensional image information.

In the image display device according to the present invention, the light source is preferably an LED light source having no polarization characteristics.

In the image display device according to the present invention, the light source is preferably adapted to emit light of the second color and light of the third color separately, and the duration of the emission of the light of the second color is different from the duration of the emission of the light of the third color.

In the image display device according to the present invention, the collimated light generating means preferably includes a collimator lens.

In the image display device according to the present invention, the collimated light generating means preferably includes a light tunnel.

In the image display device according to the present invention, the second reflective liquid crystal device receives the second color image information and the third color image information and forms an image in accordance with the second color image information and an image in accordance with the third color image information separately, wherein the duration of the formation of the image in accordance with the second color image information is different from the duration of the formation of the image in accordance with the third color image information.

In the image display device according to the present invention, the fourth reflective liquid crystal device preferably receives the second color image information and the third color image information separately, and the duration of the reception of the second color image information is different from the duration of the reception of the third color image information.

### Advantageous Effects of Invention

Since the image display device of the present invention includes first and second polarized image forming means, left eye images may be formed by one of the polarized image forming means and right eye images may be formed by the other polarized image forming means to display a three-dimensional image without the need to alternately display the right and left eye images, thus achieving substantially the same utilization of light for both two- and three-dimensional displays.

### BRIEF DESCRIPTION OF DRAWINGS

FIG. 1 is an explanatory drawing of an image display device according to the present embodiment.

FIG. 2 is an example of a spectral characteristic of a polarization changing device.

FIG. 3 is an example of a spectral characteristic of a polarization changing device.

FIG. 4 is an explanatory drawing of another image display device according to the present embodiment.

FIG. 5 is an explanatory drawing of a conventional image display device.

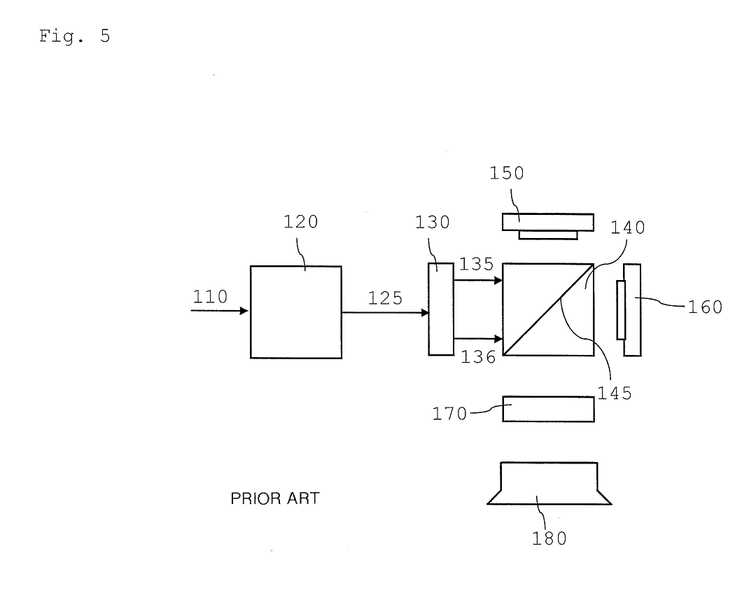

### DESCRIPTION OF EMBODIMENTS

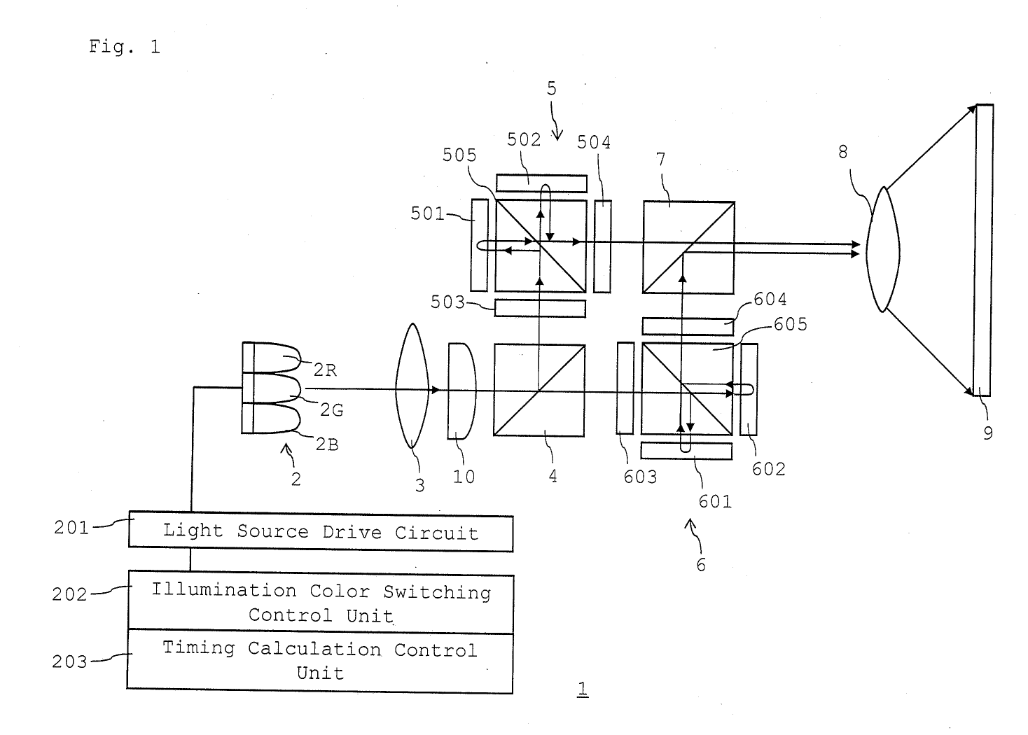

An image display device in accordance with an embodiment of the present invention will be described with reference to FIG. 1. It should be noted that in the reference diagram, the arrows indicate the traveling directions of light.

The image display device 1 includes: an LED light source 2 having no polarization characteristics; a collimator lens 3 serving as a collimated light generating means for converting light from the LED light source 2 into collimated light; a condenser lens 10 for focusing the collimated light transmitted by the collimator lens 3; a polarizing prism 4 serving as a separating means for separating the light transmitted by the condenser lens 10 into S-polarized light and P-polarized light; a first polarized image forming means 5 for forming a P-polarized image from the S-polarized light reflected from the polarizing prism 4; a second polarized image forming means 6 for forming an S-polarized image from the P-polarized light transmitted by the polarizing prism 4; a polarizing prism 7 serving as a combining means for combining the P-polarized image and the S-polarized image; a projection lens 8 serving as a projecting means for projecting the combined image; and a screen 9.

The LED light source 2 includes a red LED 2R, a green LED 2G, and a blue LED 2B. The LED light source 2 is controlled by a light source drive circuit 201. The light source drive circuit 201 is connected to a timing calculation control unit 203 through an illumination color switching control unit 202. In accordance with the present embodiment, the green LED 2G constantly emits light. The red LED 2R and the blue LED 2B, on the other hand, alternately emit light in a calculated manner. Specifically, the timing calculation control unit 203 and the illumination color switching control unit 202 control the red LED 2R and the blue LED 2B to emit light alternately at a frequency of 60 Hz. It should be noted, however, that the light emission pattern for each color is not limited to this.

In accordance with the present embodiment, it is possible to control the red LED 2R and the blue LED 2B to alternately emit light for equal lengths of time. However, the red LED 2R and the blue LED 2B may emit light for different lengths of time determined depending on the balance between the emission intensities of these LEDs.

For example, LEDs having different characteristics may differ in their emission power. If these LEDs are controlled to alternately emit light for equal lengths of time without consideration of their characteristics, the resulting displayed colors may differ in brightness. In order to prevent this, if the red LED 2R and the blue LED 2B are different in their emission power, the non-emission periods of the LED having higher emission power may be adjusted to be longer than those of the other LED, that is, the emission periods of the LED having higher emission power may be adjusted to be shorter than those of the other LED so that the red and blue colors do not differ in brightness.

When the emission periods of the red LED 2R and the blue LED 2B are adjusted, the red and blue light modulation periods of a second reflective liquid crystal device 502 and a fourth liquid crystal device 602, described later, are preferably adjusted accordingly. Specifically, a frame, which is a unit of time for displaying one image, consists of a period for modulation in accordance with red light image information and a period for modulation in accordance with blue light image information, and these periods need not have the same fixed duration, but they may be adjusted to suitable durations based on the emission power of the red and blue LEDs. That is, in one frame period, the subframe period for forming a red light image and that for forming a blue light image may be adjusted to have different durations determined in accordance with the difference in brightness between the LEDs. With this, the emission periods of the red and blue LEDs in each frame period can be set so as to avoid waste of any of these emission periods, thereby forming brighter images.

It should be noted that, instead of the LED source 2, a light source, which emits white light may be used, such as a superhigh-pressure mercury lamp, a metal halide lamp, or a xenon lamp. This, however, requires a known color separation means for separating white light into red, green, and blue light. More specifically what are required are: a first dichroic mirror for separating the white light into red light, and the remainder the remaining light is reflected from the first mirror to; a second dichroic mirror for separating the light received from the first dichroic mirror into green light, and the remainder the remaining light is reflected from the second mirror to and the remainder; a third dichroic mirror for separating blue light from the light received from the second dichroic mirror; and mirrors for reflecting the separated light in predetermined directions. Therefore, it is preferable to use an LED light source in order to make the image display device compact.

The light emitted from the LED light source 2 is transmitted and collimated by the collimator lens 3 into collimated light. This collimated light is then focused by the condenser lens 10 and separated by the polarizing prism 4 into S-polarized light and P-polarized light having orthogonal polarization axes. The separated S-polarized light and P-polarized light enter the first polarized image forming means 5 and the second polarized image forming means 6, respectively.

Instead of, or in addition to, the above collimator lens 3, a light tunnel may be used as means for converting the light emitted from the LED light source 2 into collimated light.

A light tunnel is an optical device, specifically, a type of light pipe (also referred to as homogenizer), and has a prism or pyramid shape whose faces are used to reflect light a plurality of times, thereby providing a uniform surface light source. Whereas an optical rod is a prism of transparent material, such as glass, having faces for providing total reflection, the light tunnel is a hollow structure having faces made up of mirrors. Therefore, light entering the light tunnel is repeatedly reflected inside the tunnel so that the diffusion angle of the light is reduced to a small value, and then the light is emitted from the exit face of the tunnel to the outside. That is, the light tunnel has an inherent fundamental axis, and light entering the light tunnel at an angle with respect to this fundamental axis is oriented substantially parallel to the fundamental axis before it is emitted from the tunnel.

The first polarized image forming means 5 includes: a first reflective liquid crystal device 501 which receives image information of the green light in the S-polarized light; a second reflective liquid crystal device 502 which receives image information of the blue and red light in the S-polarized light; polarization changing devices 503 and 504 serving as polarization direction control means for controlling the directions of polarization of red, green, and blue light; and a polarization beam splitter 505 serving as a light splitting/combining means for reflecting green light toward the first reflective liquid crystal device 501, transmitting red light and blue light toward the second reflective liquid crystal device 502, and combining the green light reflected from the first reflective liquid crystal device 501 and the red or blue light reflected from the second reflective liquid crystal device 502.

The first reflective liquid crystal device 501 and the second reflective liquid crystal device 502 are selected to have a high liquid crystal response speed and a high frame rate. One suitable example of such a liquid crystal device is the polarization shielded smectic (PSS) liquid crystal device, which is capable of achieving a high response speed and a wide viewing angle. See, for example, liquid crystal device: US Patent Application Publication No. 2004/196428. Another suitable example is a device called “0.61 type High Frame Rate Full HD SXRD”, which is available from Sony Corporation and capable of achieving a 120 Hz frame rate display.

Further, examples of liquid crystal devices that can be used as the first and second reflective liquid crystal devices 501 and 502 include polarization shielded smectic (PSS) liquid crystal devices (PSS-LCD), TN liquid crystal devices, IPS liquid crystal devices, VA liquid crystal devices, MVA liquid crystal devices, OCB liquid crystal devices, ferroelectric liquid crystal devices, antiferroelectric liquid crystal devices, threshold-less antiferroelectric liquid crystal devices, and liquid crystal devices using blue phase liquid crystal.

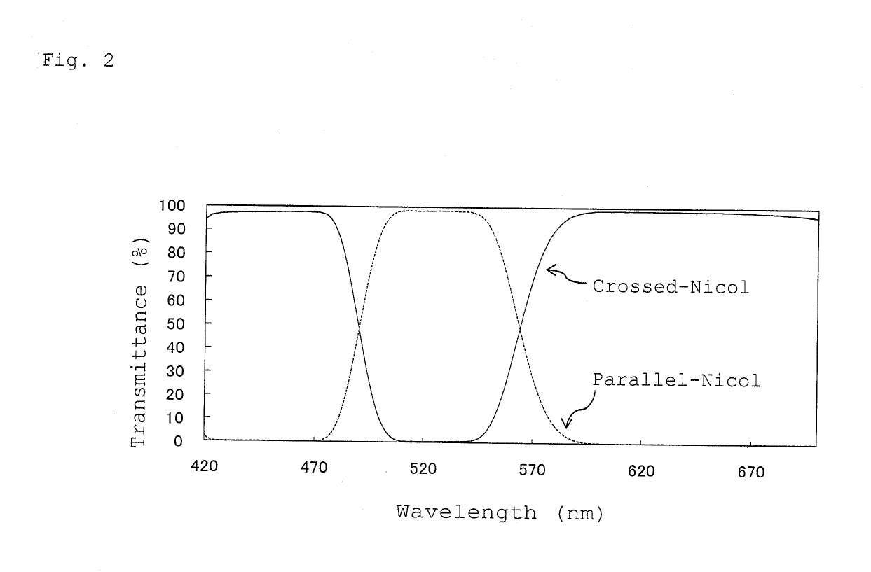

The polarization changing devices 503 and 504 have a function to convert S-polarized red and blue light into P-polarized light and transmit green light without changing the direction of polarization of the green light. A device that can be used as the polarization changing devices 503 and 504 is ColorSelect (registered trademark) available from ColorLink Japan, Ltd. FIG. 2 shows the spectral characteristics of a ColorSelect (product name: MG11). The solid line represents the spectral characteristics of a structure in which this ColorSelect is sandwiched between two polarizing plates, which are disposed in crossed-Nicol arrangement. The dashed line, on the other hand, represents the spectral characteristics of a structure in which the ColorSelect is sandwiched between two polarizing plates, which are disposed in parallel-Nicol arrangement. By using such polarization changing devices, it is possible to convert S-polarized red and blue light into P-polarized light while allowing green light to pass through without change in the direction of polarization.

The polarization beam splitter 505 is made from two right angle prisms, which are joined at their hypotenuse faces with a polarization-separating layer therebetween, which includes a dielectric multilayer film having a function to reflect S-polarized light and transmit P-polarized light.

The S-polarized light reflected from the polarizing prism 4 enters the polarization changing device 503. This S-polarized light consists of either green light and red light or green light and blue light.

Since the polarization changing device 503 does not act on green light, the green light in the S-polarized light passes through the polarization changing device 503 without being changed. The green light is then reflected from the polarization beam splitter 505 and is incident on the first reflective liquid crystal device 501. The S-polarized green light incident on the first reflective liquid crystal device 501 is modulated based on green light image information. When the green light is then reflected from the first reflective liquid crystal device 501, the direction of polarization of the green light is rotated in accordance with the modulation so that the green light becomes P-polarized light. This P-polarized green light passes through the polarization beam splitter 505 and then enters the polarization changing device 504. Since the polarization changing device 504 does not act on green light, the P-polarized green light passes through the polarization changing device 504 while retaining its P-polarization state, and then enters the polarizing prism 7.

The direction of polarization of the red light, on the other hand, is rotated 90 degrees by the polarization changing device 503 so that the red light becomes P-polarized light. This P-polarized red light then passes through the polarization beam splitter 505 and is incident on the second reflective liquid crystal device 502. The P-polarized red light incident on the second reflective liquid crystal device 502 is modulated based on red light image information. When the red light is then reflected from the second reflective liquid crystal device 502, the direction of polarization of the red light is rotated in accordance with the modulation so that the red light becomes S-polarized light. This S-polarized red light is reflected from the polarization beam splitter 505 and then enters the polarization changing device 504. The direction of polarization of the red light is then rotated 90 degrees by the polarization changing device 504 so that the red light becomes P-polarized red light which then enters the polarizing prism 7.

It should be noted that the blue light is manipulated in the same manner as the red light. Specifically, the direction of polarization of the blue light is rotated 90 degrees by the polarization changing device 503 so that the blue light becomes P-polarized light, and this P-polarized blue light passes through the polarization beam splitter 505 and is incident on the second reflective liquid crystal device 502. The P-polarized blue light is then modulated based on blue light image information. When the blue light is then reflected from the second reflective liquid crystal device 502, the direction of polarization of the blue light is rotated in accordance with the modulation so that the blue light becomes S-polarized light. This S-polarized blue light is reflected from the polarization beam splitter 505, and the direction of polarization of the blue light is then rotated 90 degrees by the polarization changing device 504 so that the blue light becomes P-polarized blue light which then enters the polarizing prism 7.

The second polarized image forming means 6 includes: a third reflective liquid crystal device 601 which receives image information of the green light in the P-polarized light; a fourth reflective liquid crystal device 602 which receives image information of the red and blue light in the P-polarized light; polarization changing devices 603 and 604 serving as polarization direction control means for controlling the directions of polarization of red, green, and blue light; and a polarization beam splitter 605 serving as a light splitting/combining means for reflecting green light toward the third reflective liquid crystal device 601, transmitting red light and blue light toward the fourth reflective liquid crystal device 602, and combining the green light reflected from the third reflective liquid crystal device 601 and the red or blue light reflected from the fourth reflective liquid crystal device 602.

The third reflective liquid crystal device 601 and the fourth reflective liquid crystal device 602 are selected to have a high liquid crystal response speed and a high frame rate. One suitable example of such a liquid crystal device is the polarization shielded smectic (PSS) liquid crystal device, which is capable of achieving a high response speed and a wide viewing angle. See, for example, liquid crystal device: US Patent Application Publication No. 2004/196428. Another suitable example is a device called “0.61 type High Frame Rate Full HD SXRD”, which is available from Sony Corporation and capable of achieving a 120 Hz frame rate display. The use of liquid crystal having a high response speed makes it possible to provide an image display device capable of high speed writing and of switching frame images at a high rate.

Further, examples of liquid crystal devices that can be used as the third and fourth reflective liquid crystal devices 601 and 602 include polarization shielded smectic (PSS) liquid crystal devices (PSS-LCD), TN liquid crystal devices, IPS liquid crystal devices, VA liquid crystal devices, MVA liquid crystal devices, OCB liquid crystal devices, ferroelectric liquid crystal devices, antiferroelectric liquid crystal devices, threshold-less antiferroelectric liquid crystal devices, and liquid crystal devices using blue phase liquid crystal.

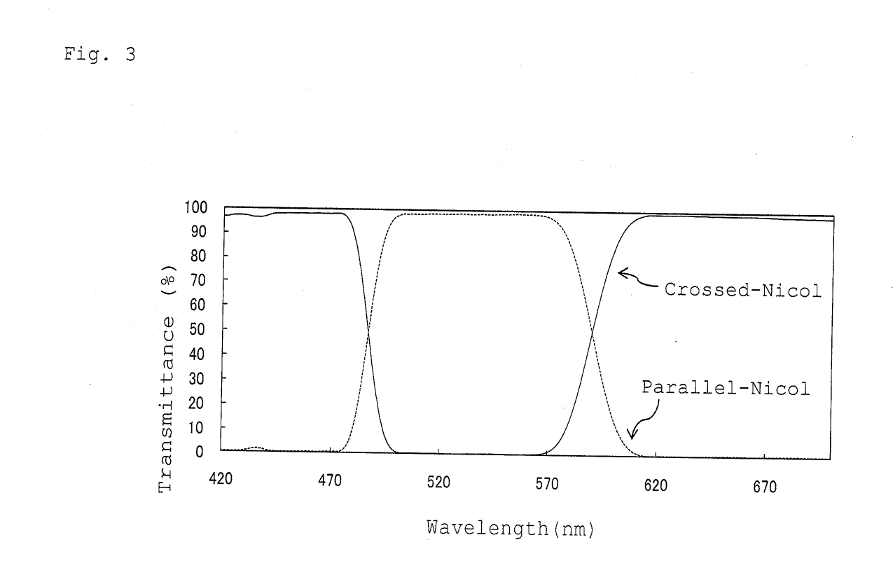

The polarization changing devices 603 and 604 have a function to convert P-polarized green light into S-polarized light and transmit red light and blue light without changing their directions of polarization. A device that can be used as the polarization changing devices 603 and 604 is ColorSelect (registered trademark) available from ColorLink Japan, Ltd. FIG. 3 shows the spectral characteristics of a ColorSelect (product name: GM44). The solid line represents the spectral characteristics of a structure in which this ColorSelect is sandwiched between two polarizing plates which are disposed in crossed-Nicol arrangement. The dashed line, on the other hand, represents the spectral characteristics of a structure in which the ColorSelect is sandwiched between two polarizing plates which are disposed in parallel-Nicol arrangement. By using such polarization changing devices, it is possible to convert P-polarized green light into S-polarized light while allowing red light and blue light to pass through without change in their directions of polarization.

The polarization beam splitter 605 is made from two right angle prisms, which are joined at their hypotenuse faces with a polarization-separating layer therebetween, which includes a dielectric multilayer film having a function to reflect S-polarized light and transmit P-polarized light.

The P-polarized light transmitted by the polarizing prism 4 enters the polarization changing device 603. This P-polarized light consists of either green light and red light or green light and blue light.

The polarization changing device 603 rotates the direction of polarization of the green light by 90 degrees so that the green light becomes S-polarized light. This S-polarized green light is then reflected from the polarization beam splitter 605 and is incident on the third reflective liquid crystal device 601. The S-polarized green light incident on the third reflective liquid crystal device 601 is modulated based on green light image information. When the green light is then reflected from the third reflective liquid crystal device 601, the direction of polarization of the green light is rotated in accordance with the modulation so that the green light becomes P-polarized light. This P-polarized green light then passes through the polarization beam splitter 605 and enters the polarization changing device 604. The direction of polarization of the green light is then rotated 90 degrees by the polarization changing device 604 so that the green light becomes S-polarized light which then enters the polarizing prism 7.

On the other hand, since the polarization changing device 603 does not act on red light, the P-polarized red light passes through the polarization changing device 603 while retaining its P-polarization state. The red light then passes through the polarization beam splitter 605 and is incident on the fourth reflective liquid crystal device 602. The P-polarized red light incident on the fourth reflective liquid crystal device 602 is modulated based on red light image information. When the red light is then reflected from the fourth reflective liquid crystal device 602, the direction of polarization of the red light is rotated in accordance with the modulation so that the red light becomes S-polarized light. This S-polarized red light is reflected from the polarization beam splitter 605 and then enters the polarization changing device 604. Since the polarization changing device 604 does not act on red light, the S-polarized red light passes through the polarization changing device 604 while retaining its S-polarization state, and then enters the polarizing prism 7.

It should be noted that the blue light is manipulated in the same manner as the red light. Specifically, the blue light passes through the polarization changing device 603 while retaining its P-polarization state. The blue light then passes through the polarization beam splitter 605 and is incident on the fourth reflective liquid crystal device 602. The P-polarized blue light incident on the fourth reflective liquid crystal device 602 is modulated based on blue light image information. When the blue light is then reflected from the fourth reflective liquid crystal device 602, the direction of polarization of the blue light is rotated in accordance with the modulation so that the blue light becomes S-polarized light. This S-polarized blue light is reflected from the polarization beam splitter 605, then enters and passes through the polarization changing device 604 while retaining its S-polarization state, and then enters the polarizing prism 7.

Thus, either P-polarized green light and red light or P-polarized green light and blue light are emitted from the first polarized image forming means 5 and enter the polarizing prism 7. On the other hand, either S-polarized green light and red light or S-polarized green light and blue light are emitted from the second polarized image forming means 6 and enter the polarizing prism 7. The polarizing prism 7 combines the P-polarized image from the first polarized image forming means 5 and the S-polarized image from the second polarized image forming means 6. The combined image is projected onto the screen 9 through the projection lens 8 serving as a projecting means for projecting an image.

In accordance with the present embodiment, it is possible to selectively switch the image display device between two-dimensional image information and three-dimensional image information. Specifically, when two-dimensional image information is input to the first reflective liquid crystal device 501, the second reflective liquid crystal device 502, the third reflective liquid crystal device 601, and the fourth reflective liquid crystal device 602, a two-dimensional image is projected onto the screen 9. This image consists of P-polarized and S-polarized images all having the same parallax. On the other hand, when three-dimensional information, which includes information about the parallax between the right and left eyes, is input to the first reflective liquid crystal device 501, the second reflective liquid crystal device 502, the third reflective liquid crystal device 601, and the fourth reflective liquid crystal device 602, the observer can perceive a three-dimensional image by looking at the image projected onto the screen 9 while wearing polarized glasses which include polarizing plates each corresponding to one of the directions of polarization for the left and right. In this case, for example, the P-polarized image may be a left eye image, and the S-polarized image may be a right eye image.

Thus, in the configuration of the present embodiment, one polarized image forming means forms left eye images while the other polarized image forming means forms right eye images, meaning that a three-dimensional display can be achieved without the need to alternate between the right and left eye images. That is, a three-dimensional display can be achieved without sacrificing resolution.

Further, it is possible to selectively switch between a two-dimensional image display and a three-dimensional image display merely by switching between two-dimensional image information and three-dimensional image information for input to the reflective liquid crystal devices, so that the image display device can achieve substantially the same utilization of light for both two-dimensional and three-dimensional displays.

It should be noted that a three-panel system can be adapted to display a three-dimensional image without substantial increase in its size by employing three polarization beam splitters and reflective liquid crystal devices capable of display at a frame rate of, e.g., 120 Hz, and alternating between right and left eye images in a calculated manner. However, this method requires a polarization changing optical system for polarizing the illumination light, resulting in reduced utilization of light.

Further, the image display device of the present embodiment can provide a three-dimensional display free of flicker and having good moving image characteristics, as compared to systems in which left and right eye images are alternately projected onto the screen using liquid crystal shutters.

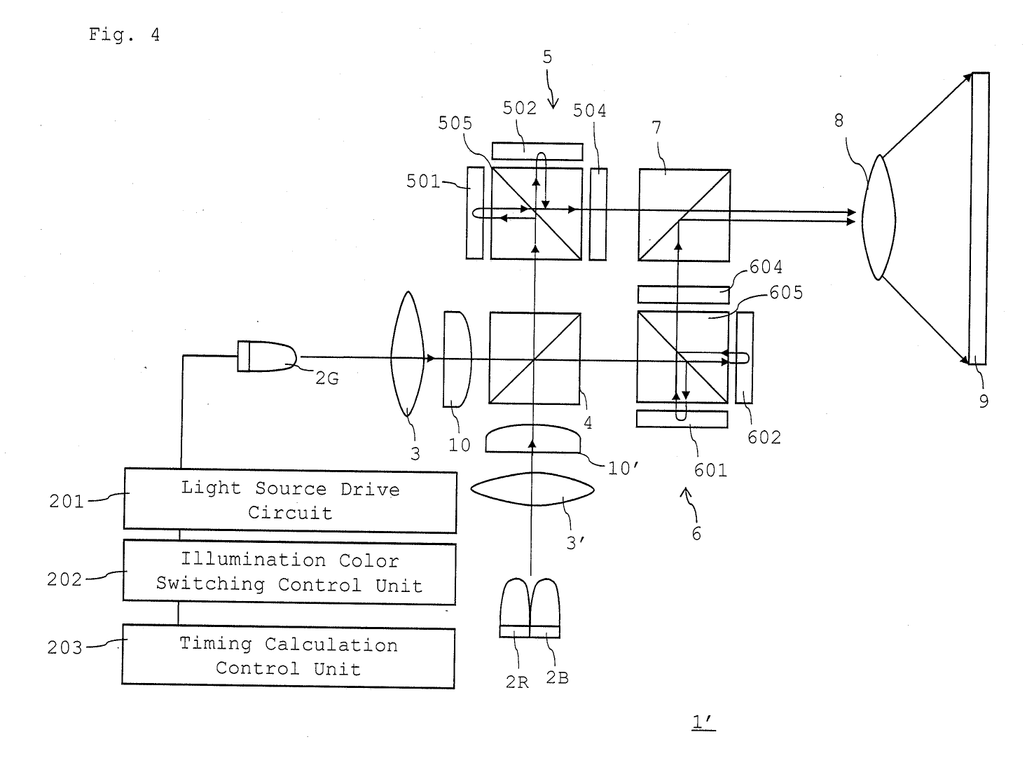

In accordance with the present embodiment, light may be directed to enter the system from a direction different than that shown in FIG. 1. FIG. 4 shows such an example. It should be noted that in FIG. 4, parts identical to those in FIG. 1 bear the same reference numerals.

In FIG. 4, the light emitted from LED sources enters an image display device 1′ from two directions. Specifically, whereas the light emitted from the green LED 2G enters the device from the same direction as in FIG. 1, the light emitted from the red LED 2R and the blue LED 2B enters the device from a direction perpendicular to the incident direction of the light from the green LED 2G. It should be noted that the green LED 2G constantly emits light while the red LED 2R and the blue LED 2B alternately emit light in a calculated manner, as in the example shown in FIG. 1. Further, the red LED 2R and the blue LED 2B are controlled by the timing calculation control unit 203 and the illumination color switching control unit 202 to emit light alternately at a frequency of 60 Hz. It should be noted, however, that the light emission pattern for each color is not limited to this. Further, the red LED 2R and the blue LED 2B may be controlled to alternately emit light for equal lengths of time, or alternatively, the red LED 2R and the blue LED 2B may emit light for different lengths of time determined depending on the balance between the emission intensities of these LEDs.

The light emitted from the green LED 2G passes through and is collimated by the collimator lens 3 into collimated light. This collimated light is then focused by the condenser lens 10 and separated by the polarizing prism 4 into S-polarized light and P-polarized light having orthogonal polarization axes. The separated S-polarized light and P-polarized light enter the first polarized image forming means 5 and the second polarized image forming means 6, respectively.

The light emitted from the red LED 2R and the blue LED 2B, on the other hand, passes through and is collimated by a collimator lens 3′ into collimated light. This collimated light is then focused by a condenser lens 10′ and separated by the polarizing prism 4 into S-polarized light and P-polarized light having orthogonal polarization axes. The separated P-polarized light and S-polarized light enter the first polarized image forming means 5 and the second polarized image forming means 6, respectively.

The first polarized image forming means 5 includes: a first reflective liquid crystal device 501 which receives image information of the S-polarized green light; a second reflective liquid crystal device 502 which receives image information of the P-polarized red and blue light; a polarization changing device 504 serving as a polarization direction control means for controlling the directions of polarization of red, green, and blue light; and a polarization beam splitter 505 serving as a light splitting/combining means for reflecting green light toward the first reflective liquid crystal device 501, transmitting red light and blue light toward the second reflective liquid crystal device 502, and combining the green light reflected from the first reflective liquid crystal device 501 and the red or blue light reflected from the second reflective liquid crystal device 502.

The first reflective liquid crystal device 501 and the second reflective liquid crystal device 502 are selected to have a high liquid crystal response speed and a high frame rate. One suitable example of such a liquid crystal device is the polarization shielded smectic (PSS) liquid crystal device, which is capable of achieving a high response speed and a wide viewing angle.

The polarization changing device 504 converts S-polarized red and blue light into P-polarized light, and transmits green light without changing the direction of polarization of the green light.

The polarization beam splitter 505 is made from two right angle prisms, which are joined at their hypotenuse faces with a polarization-separating layer therebetween, which includes a dielectric multilayer film having a function to reflect S-polarized light and transmit P-polarized light.

The S-polarized green light reflected from the polarizing prism 4 is further reflected by the polarization beam splitter 505 and is incident on the first reflective liquid crystal device 501. The S-polarized green light incident on the first reflective liquid crystal device 501 is modulated based on green light image information. When the green light is then reflected from the first reflective liquid crystal device 501, the direction of polarization of the green light is rotated in accordance with the modulation so that the green light becomes P-polarized light. This P-polarized green light then passes through the polarization beam splitter 505 and enters the polarization changing device 504. Since the polarization changing device 504 does not act on green light, the P-polarized green light passes through the polarization changing device 504 while retaining its P-polarization state, and then enters the polarizing prism 7.

The P-polarized red light transmitted by the polarizing prism 4, on the other hand, passes through the polarization beam splitter 505 and is incident on the second reflective liquid crystal device 502. The P-polarized red light incident on the second reflective liquid crystal device 502 is modulated based on red light image information. When the red light is then reflected from the second reflective liquid crystal device 502, the direction of polarization of the red light is rotated in accordance with the modulation so that the red light becomes S-polarized light. This S-polarized red light is reflected from the polarization beam splitter 505 and then enters the polarization changing device 504. The direction of polarization of the red light is then rotated 90 degrees by the polarization changing device 504 so that the red light becomes P-polarized red light which then enters the polarizing prism 7.

It should be noted that the blue light is manipulated in the same manner as the red light. Specifically, the blue light passes through the polarization beam splitter 505 and is incident on the second reflective liquid crystal device 502. The blue light is then modulated in the second reflective liquid crystal device 502 based on blue light image information. When the blue light is then reflected from the second reflective liquid crystal device 502, the direction of polarization of the blue light is rotated in accordance with the modulation so that the blue light becomes S-polarized light. This S-polarized blue light is reflected from the polarization beam splitter 505. The direction of polarization of the blue light is then rotated 90 degrees by the polarization changing device 504 so that the blue light becomes P-polarized blue light which then enters the polarizing prism 7.

The second polarized image forming means 6 includes: a third reflective liquid crystal device 601 which receives image information of S-polarized red and blue light; a fourth reflective liquid crystal device 602 which receives image information of P-polarized green light; a polarization changing device 604 serving as a polarization direction control means for controlling the directions of polarization of red, green, and blue light; and a polarization beam splitter 605 serving as a light splitting/combining means for reflecting red and blue light toward the third reflective liquid crystal device 601, transmitting green light toward the fourth reflective liquid crystal device 602, and combining the red and blue light reflected from the third reflective liquid crystal device 601 and the green light reflected from the fourth reflective liquid crystal device 602.

The third reflective liquid crystal device 601 and the fourth reflective liquid crystal device 602 are selected to have a high liquid crystal response speed and a high frame rate. One suitable example of such a liquid crystal device is the polarization shielded smectic (PSS) crystal device, which is capable of achieving a high response speed and a wide viewing angle.

The polarization changing device 604 has a function to convert P-polarized red and blue light into S-polarized light, and transmit green light without changing the direction of polarization of the green light.

The polarization beam splitter 605 is made from two right angle prisms, which are joined at their hypotenuse faces with a polarization-separating layer therebetween, which includes a dielectric multilayer film having a function to reflect S-polarized light and transmit P-polarized light.

The P-polarized green light transmitted by the polarizing prism 4 passes through the polarization beam splitter 605 and is incident on the fourth reflective liquid crystal device 602. The P-polarized green light incident on the fourth reflective liquid crystal device 602 is modulated based on green light image information. When the green light is then reflected from the fourth reflective liquid crystal device 602, the direction of polarization of the green light is rotated in accordance with the modulation so that the green light becomes S-polarized light. This S-polarized green light is reflected from the polarization beam splitter 605 and then enters the polarization changing device 604. Since the polarization changing device 604 does not act on green light, the S-polarized green light passes through the polarization changing device 604 while retaining its S-polarization state, and then enters the polarizing prism 7.

The S-polarized red light reflected from the polarizing prism 4, on the other hand, is further reflected by the polarization beam splitter 605 and is incident on the third reflective liquid crystal device 601. The S-polarized red light incident on the third reflective liquid crystal device 601 is modulated based on red light image information. When the red light is then reflected from the third reflective liquid crystal device 601, the direction of polarization of the red light is rotated in accordance with the modulation so that the red light becomes P-polarized light. This P-polarized red light then passes through the polarization beam splitter 605 and enters the polarization changing device 604. The direction of polarization of the red light is then rotated 90 degrees by the polarization changing device 604 so that the red light becomes S-polarized light which then enters the polarizing prism 7.

It should be noted that the blue light is manipulated in the same manner as the red light. Specifically, the S-polarized blue light is reflected from the polarization beam splitter 605 and is incident on the third reflective liquid crystal device 601. The S-polarized blue light incident on the third reflective liquid crystal device 601 is then modulated based on blue light image information. When the blue light is then reflected from the third reflective liquid crystal device 601, the direction of polarization of the blue light is rotated in accordance with the modulation so that the blue light becomes P-polarized light. This P-polarized blue light passes through the polarization beam splitter 605 and then enters the polarization changing device 604. The direction of polarization of the blue light is then rotated 90 degrees by the polarization changing device 604 so that the blue light becomes S-polarized light which then enters the polarizing prism 7.

Thus, either P-polarized green light and red light or P-polarized green light and blue light are emitted from the first polarized image forming means 5 and enter the polarizing prism 7. On the other hand, either S-polarized green light and red light or S-polarized green light and blue light are emitted from the second polarized image forming means 6 and enter the polarizing prism 7. The polarizing prism 7 combines the P-polarized image from the first polarized image forming means 5 and the S-polarized image from the second polarized image forming means 6. The combined image is projected onto the screen 9 through the projection lens 8 serving as a projecting means for projecting an image.

The example shown in FIG. 4 does not require the polarization changing devices 503 and 603 shown in FIG. 1. Further, the emitting areas of the light sources may be reduced to increase the utilization of light. That is, in accordance with the present invention, any suitable combination of red, blue, and green light may be employed depending on the emission characteristics of the light sources.

It will be understood that the present invention is not limited to the embodiment described above, and various alterations may be made thereto without departing from the spirit and scope of the invention.

For example, the reflective liquid crystal devices may be replaced by transmissive liquid crystal devices.

Further, although the above embodiment uses polarization beam splitters having a function to reflect S-polarized light and transmit P-polarized light, it is possible to use polarization beam splitters having a function to reflect P-polarized light and transmit S-polarized light. In this case, such polarization beam splitters 505′ and 605′ (not shown) are substituted for the polarization beam splitters 505 and 605 shown in FIG. 1. As a result, the S-polarized green light passes through the polarization beam splitter 505′, while the S-polarized red and blue light is converted by the polarization changing device 503 into P-polarized light which is then reflected by the polarization beam splitter 505′. Therefore, the positions of the first reflective liquid crystal device 501 and the second reflective liquid crystal device 502 shown in FIG. 1 need be swapped. On the other hand, the P-polarized green light is converted by the polarization changing device 603 into S-polarized light which then passes through the polarization beam splitter 605′, while the P-polarized red and blue light is reflected by the polarization beam splitter 605′. Therefore, the positions of the third liquid crystal device 601 and the fourth liquid crystal device 602 shown in FIG. 1 need be swapped.

Further, in FIG. 1, absorption polarizing plates may be interposed between the polarizing prism 7 and the first polarized image forming means 5 and between the polarizing prism 7 and the second polarized image forming means 6 so as to block light in a disturbed polarization state. This makes it possible to prevent crosstalk when displaying a three-dimensional image.

1-8. (canceled)

9. An image display apparatus comprising:
a first light source and a second light source;
a plurality of collimator lenses for converting light from the first light source and from the second light source into collimated light;
a condenser lens for focusing the collimated light;
a first polarizing prism, serving as separating means, for separating the collimated light into S-polarized light and P-polarized light;
first polarized image forming means for forming a P-polarized image from the S-polarized light reflected from the first polarizing prism;
second polarized image forming means for forming an S-polarized image from the P-polarized light transmitted by the first polarizing prism;
a second polarizing prism, serving as a combiner, for combining the P-polarized image and the S-polarized image into a combined image;
a projection lens for projecting the combined image; and
a screen onto which the combined image may be projected.

10. The image display apparatus according to claim 9, wherein the light emitted from the second light source enters the display apparatus along a direction perpendicular to the direction of emission of the light from the first light source.

11. The image display apparatus according to claim 9, wherein the first light source and the second light source are light emitting diode (LED) light sources.

12. The image display apparatus according to claim 11, wherein the first light source comprises a green LED emitting green light, and the green LED constantly emits light.

13. The image display apparatus according to claim 12, wherein the second light source comprises a red LED emitting red light and a blue LED emitting blue light, the red LED and the blue LED emitting light alternately, at a frequency of at least 60 Hz.

14. The image display apparatus according to claim 12, wherein the second light source comprises a red LED emitting red light and a blue LED emitting blue light, separately emitting light, and duration of emission of light from the red LED is different from the duration of emission of light from the blue LED.

15. The image display apparatus according to claim 9, including a light tunnel for converting the light emitted from the first and second light sources.

16. The image display apparatus according to claim 9, wherein the combined image can be selectively switched between two-dimensional image information and three-dimensional image information.

17. The image display apparatus according to claim 9, wherein the first polarizing image forming means comprises:
a first reflective liquid crystal device;
a second reflective liquid crystal device;
a polarization changing device; and
a polarization beam splitter as a light splitter/combiner.

18. The image display apparatus according to claim 9, wherein the second polarizing image forming means comprises:
a first reflective liquid crystal device;
a second reflective liquid crystal device;
a polarization changing device; and
a polarization beam splitter as a light splitter/combiner.

19. An image display method comprising:
emitting light from first and second light sources so that the light from the first light source enters a first polarizing prism from a first direction, and light from the second light source enters the first polarizing prism from a second direction, perpendicular to the first direction;
separating the light entering the first polarizing prism into S-polarized light and P-polarized light via the first polarizing prism;
forming a P-polarized image from the S-polarized light by transmitting the P-polarized light through or reflecting the P-polarized light from a polarized image forming means;
forming an S-polarized image from the S-polarized light:
combining the P-polarized image and the S-polarized image via a second polarizing prism and forming a combined image; and
projecting the combined image.

20. An image display apparatus comprising:
a light source;
a collimator lens for converting light from the light source into collimated light;
a condenser lens for focusing the collimated light;
a first polarizing prism, serving as separating means, for separating the collimated light into S-polarized light and P-polarized light;
first polarized image forming means for forming a P-polarized image from the S-polarized light reflected from the first polarizing prism;
second polarized image forming means for forming an S-polarized image from the P-polarized light transmitted by the first polarizing prism;
a second polarizing prism, serving as a combiner, for combining the P-polarized image and the S-polarized image into a combined image;
a projection lens for projecting the combined image; and
a screen onto which the combined image may be projected.

21. The image display apparatus according to claim 20, wherein the light source is a light emitting diode (LED) light source.

22. The image display apparatus according to claim 21, wherein the light source comprises a green LED emitting green light, a blue LED emitting blue light, and a red LED emitting red light, wherein the green LED constantly emits light.

23. The image display apparatus according to claim 22, wherein the red LED and the blue LED emit light separately, and duration of emission of light from the red LED is different from the duration of emission of light from the blue LED.

24. The image display apparatus according to claim 22, wherein the red LED and the blue LED emit light alternately, at a frequency of at least 60 Hz.

25. The image display apparatus according to claim 21, including a light tunnel for converting the light emitted from the light source.

26. The image display apparatus according to claim 21, wherein the combined image can be selectively switched between two-dimensional image information and three-dimensional image information.

27. The image display apparatus according to claim 20, wherein the first polarizing image forming means comprises:
a first reflective liquid crystal device;
a second reflective liquid crystal device;
two polarization changing devices; and
a polarization beam splitter as a light splitter/combiner.

28. The image display apparatus according to claim 20, wherein the second polarizing image forming means comprises:
a first reflective liquid crystal device;
a second reflective liquid crystal device;
two polarization changing devices;
a polarization beam splitter as a light splitter/combiner.

29. An image display method comprising:
emitting light from a light source;
converting the light emitted from the light source into collimated light;
separating the collimated light, in a polarizing prism, into S-polarized light and P-polarized light;
transmitting through or reflecting from a first polarized image forming means the S-polarized light and forming a P-polarized image from the S-polarized light; and
forming an S-polarized image from the P-polarized light with a second polarized image forming means;
combining the P-polarized image and the S-polarized image to form a combined image; and
projecting the combined image.
